(19) United States
(12) Patent Application Publication
(10) Pub. No.: US 2008/0290136 A1
(43) Pub. Date: Nov. 27, 2008

(54) SOLDER SUPPLYING METHOD

(75) Inventor: Kei Murayama, Nagano-shi (JP)

Correspondence Address: RANKIN, HILL & CLARK LLP, 38210 Glenn Avenue, WILLOUGHBY, OH, 44094-7808, US

(73) Assignee: SHINKO ELECTRIC INDUSTRIES CO., LTD., Nagano-shi (JP)

(21) Appl. No.: 12/126,336

(22) Filed: May 23, 2008

(30) Foreign Application Priority Data
May 25, 2007 (JP) 2007-138785

(51) Int. Cl. B23K 1/00

(52) U.S. Cl. 228/8

(57) ABSTRACT

Amounts of a solder are controlled to supply onto the respective connection terminals with different opening diameters such that a difference between contents of a substance diffused from the connection terminals into the solder, which is present in the solder after reflow on the connection terminals with the different opening diameters becomes equal to or smaller than 0.2 wt %.

This application claims priority to Japanese Patent Application No. 2007-138785, filed May 25, 2007, in the Japanese Patent Office. The Japanese Patent Application No. 2007-138785 is incorporated by reference in its entirety.

### TECHNICAL FIELD

The present disclosure relates to a solder supplying method. More specifically, the present disclosure relates to a method of supplying a solder to pads having different opening diameters on a flip chip substrate or the like such that solder compositions after reflow become constant or substantially constant.

### RELATED ART

A flip chip substrate is used for mounting a semiconductor chip on a board to be mounted by flip chip bonding. The flip chip substrate has a pad for input/output of the chip and a pad for a power source supply/grounding. The pads are disposed at opening portions of a solder resist covering the substrate. An opening diameter of the solder resist for the chip input/output pad is small and the opening diameter for the pad for power source supply/grounding is large. The pad is provided on a wiring of a material of copper or the like and, for example, is fabricated by successively forming nickel (Ni) and gold (Au) on the wiring.

FIG. 1 shows a substrate provided with such pads. In a substrate 1, pads 4 and 5 respectively formed on a wiring 2 for chip input/output and on a wiring 3 for power source supply/grounding are disposed at opening portions 7 and 8 of a solder resist layer 6. The wiring 2 for chip input/output is slenderer than the wiring 3 for power source supply/grounding, in correspondence therewith, the pads 4 connected to the former is smaller than the pad 5 connected to the latter in a diameter thereof, and the opening portion 7 for the former of the solder resist layer exposing these is formed to be smaller than the opening portion 8 for the latter. The respective opening portions 7 and 8 are arranged with solder bumps 9 (for chip input/output) and 10 (for power source supply/grounding) to be connected to electrodes (pads) of a semiconductor chip (not illustrated). Although an opposed side (back face) of the substrate 1 is provided with a pad for connecting to the board to be mounted and a solder resist layer having an opening portion exposing the pad, these are not illustrated in the drawing for simplifying.

The pads 4 and 5 are fabricated by successively forming an Ni layer and an Au layer on the wirings 2 and 3. Otherwise, there is also used a pad arranging a Pd layer on an Ni layer, or a pad arranging a Pd layer and an Au layer above a Ni layer.

The solder bumps 9 and 10 are formed by arranging solder balls having predetermined diameters on the pads 4 and 5 to reflow, or transcribing a predetermined amount of a solder by screen printing to reflow.

When a chip is mounted on a substrate with solder bumps, which are formed on pads having different opening diameters by reflow, and the chip is bonded to the substrate by making the solder bumps reflow, there is a case of bringing about a connection failure at one of pad portions having different opening diameters.

Further, when it is necessary to heat a solder having a high melting point to a temperature considerably higher than a melting point of a solder having a low melting point, there is also a case in which a portion of the solder having the low melting point flows out to connect contiguous bonded portions of the pads of the substrate and the pads of the chip, as a result, shortcircuit is caused.

### SUMMARY

Exemplary embodiments of the present invention provide a method of supplying a solder to a substrate.

A solder supplying method according to the invention is a method of supplying a solder to connection terminals having different opening diameters of a substrate In the method, amounts of the solder are controlled to supply onto the respective connection terminals such that a difference between contents of a substance diffused from the connection terminals into the solder by reflow, which is present in the solder after reflow on the connection terminals having the different opening diameters becomes equal to or smaller than 0.2 wt %.

Preferably, the difference between the contents of the substance diffused from the connection terminals into the solder is equal to or smaller than 0.1 wt %, further preferably, equal to or smaller than 0.05 wt %.

The solder can be supplied onto the connection terminal by screen printing, in this case, the amount of supplying the solder can be controlled by adjusting a mask diameter of the screen printing. The solder can be supplied onto the connection terminal by a solder ball, in this case, the amount of supplying the solder can be controlled by adjusting a diameter of the solder ball. Further, a solder melted by a melting method can also be supplied.

According to the invention, the solder can be supplied to the connection terminals (pads) having the different opening diameters such that a solder composition after reflow becomes constant or substantially constant, thereby, a connection failure which is liable to occur at one of pad portions having different opening diameters can be avoided. Further, shortcircuit caused by making a portion of a solder of a bump flow out in reflow can also be restrained from occurring.

Other features and advantages maybe apparent from the following detailed description, the accompanying drawings and the claims.

### BRIEF DESCRIPTION OF THE DRAWINGS

FIG. 1 is a schematic view for explaining a substrate to which a method of the invention is applied.

FIG. 2 is a view schematically explaining a substrate after a chip is mounted onto a substrate with bumps having different solidifying points, reflow of a solder of the bump is performed, and then a temperature is lowered.

FIG. 3 is a graph showing representative relationships between Au contents in solders and change amounts of solidifying points of the respective solders.

FIG. 4 is a graph showing a relationship between a solder resist opening diameter and an amount of Au diffused from a pad in a solder.

### DETAILED DESCRIPTION

After carrying out investigations for clarifying a cause of bringing about a connection failure or shortcircuit when chips are mounted on a substrate provided with pads constituting connection terminals having different opening diameters, the inventor has found that the cause resides in a change in a solder composition of a bump by reflow in forming the bump of the substrate. Explaining by taking an example of a pad formed by an Ni layer and an Au layer, a reflow processing utilized in forming a solder bump is accompanied by heating, and therefore, in that occasion, an Au material of the pad is diffused into a solder, only the Ni layer remains in the final pad. Au diffused into the solder changes a composition of the solder as a result. There is a pad arranging a Pd layer on an Ni layer, or arranging a Pd layer and an Au layer on an Ni layer, also in these pads, Pd or Au diffuses into the solder by reflow to change a composition thereof.

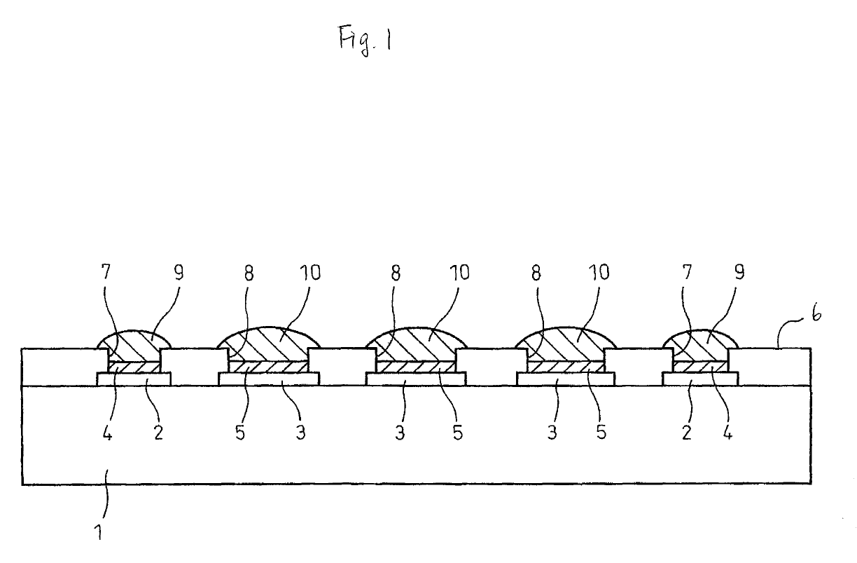

In reference to FIG. 1 explained above, when the opening portions 7 and 8 having the different opening diameters are present in the solder resist layer, the pads 4 and 5 in the opening portions are formed by the Ni layer and the Au layer (not illustrated) having the same thickness, and therefore, amounts of Au diffused into the solder by reflow differ for the pad 4 for chip input/output and the pad 5 for power source supply/grounding. Therefore, solder compositions after reflow differ (Au amounts in solder differ) in the bump 9 for chip input/output and the bump 10 for power source supply/grounding, and melting points and solidifying points thereof also differ in accordance therewith.

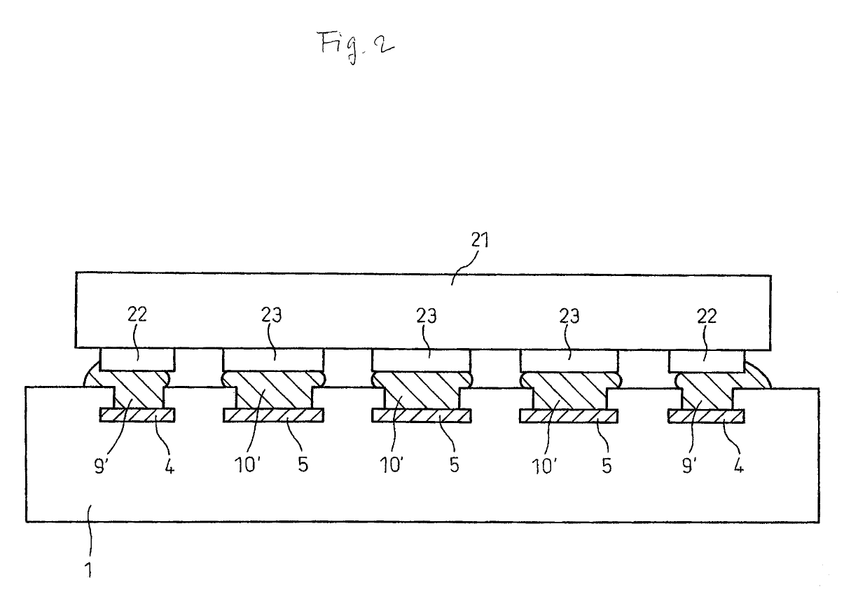

When chips are mounted on the substrate with the bumps having different melting points and solidifying points and solder of the bumps are made to reflow, in the procedure of solidifying the solder by lowering temperature after the reflow, when the bump having the low solidifying point is still brought into a molten state, only the bump having the high solidifying point is precedingly solidified. It is shown in FIG. 2 schematically. FIG. 2 schematically shows a substrate after a chip 21 is mounted on the substrate 1 (for simplifying, other than the pad 4 for chip input/output and the pad 5 for power source supply/grounding is omitted), reflow of solder of bumps is performed and then a temperature is lowered. In FIG. 2, a solder 10′ of the bump 10 for power source supply/grounding (FIG. 1) is solidified, and a solder 9′ of the bump 9 for chip input/output (FIG. 1) remains to be melted and a portion of the solder 9′ flows out.

When such a phenomenon occurs, a connection failure by the solders 9′ and 10′ of the pads 4 and 5 of the substrate 1 and the pads 22 and 23 of the chip 21 is liable to occur. Further, shortcircuit by bringing the solder flowing out from a bonded portion of the pad of the substrate and the pad of the chip into contact with the solder of a contiguous bonded portion of the pad of the substrate and the pad of the chip both is liable to occur.

Hence, according to the invention, there is resolved the problem by controlling to supply amounts of the solder to respective connection terminals such that a difference of contents of a substance diffused from the pads into the solder by reflow, which are present in the solder after reflow on the pads (connection terminals) having different opening diameters become equal to or smaller than 0.2 wt %.

According to the invention, the amounts of the solder supplied onto the pads (connection terminals) having different opening diameters can be controlled such that the difference between the contents of the substance diffused from the pads in the solder after reflow becomes equal to or smaller than 0.2 wt % by adjusting mask diameters of screen printing.

Supply of the solder can also be carried out by using a solder ball, in this case, by adjusting a diameter of the ball, the amounts of the solder supplied to the pads having the different opening diameters can be controlled.

Supply of the solder can also be carried out utilizing a melting method. According to the melting method, the solder melted at inside of a vessel in a nitrogen atmosphere is supplied to a predetermined pad through a nozzle. The nozzle detects a position of a pad to be supplied with the solder and is moved to the position. For example, the amount of supply of the solder to the pad can be adjusted by a piezoelectric actuator provided at a front end portion of the nozzle.

Further, by thinning a thickness of the Au layer or Pd layer of the pad, the difference between the contents of the substances diffused in the solder after reflow on the pads having the different opening diameters can also be reduced.

For the object of the invention, the smaller the difference between the contents of the substance diffused from the pads in the solder after reflow, the better. However, there is a variation of a temperature within a surface heated in actual reflow, the difference in the solder solidifying points cannot necessarily be resolved only by adjusting the contents of the diffused substances. The inventor has found that the difference between the solder solidifying points can be restrained to about 1° C. when the difference between the contents of the diffused substances in the solder is made to be equal to or smaller than 0.2 wt % even in consideration of the variation in the heating temperature within the surface from a practical point of view, and the chip and the substrate can be bonded to a practically nonproblematic level thereby. However, the smaller the difference between the contents of the diffused substance of the solder, the better, and thus, the difference is preferably equal to or smaller than 0.1 wt %, further preferably, equal to or smaller than 0.05 wt %.

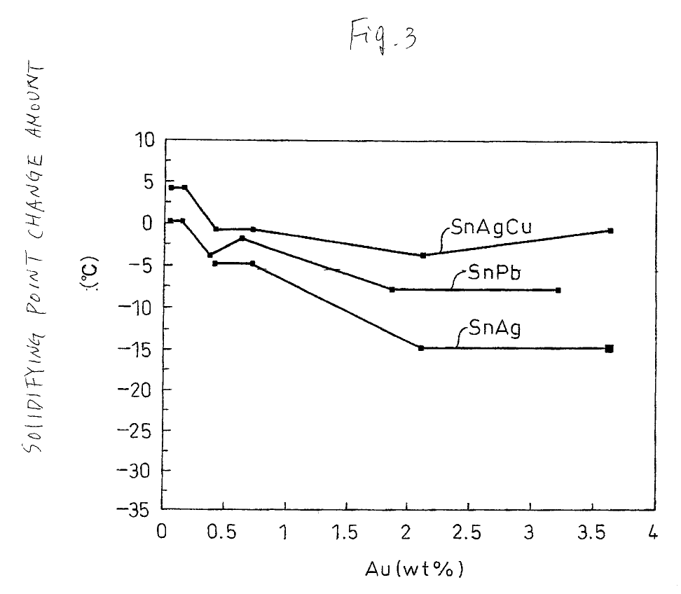

Although a relationship between the content of the substance diffused from the pad in the solder and an amount of the change in the solder solidifying point depends on a kind of a solder, the relationship can simply be investigated by an experiment. As an example, a graph of FIG. 3 shows representative relationships between Au contents in SnAgCu solder, SnAg solder, and SnPb solder and change amounts of solidifying points of respective solders.

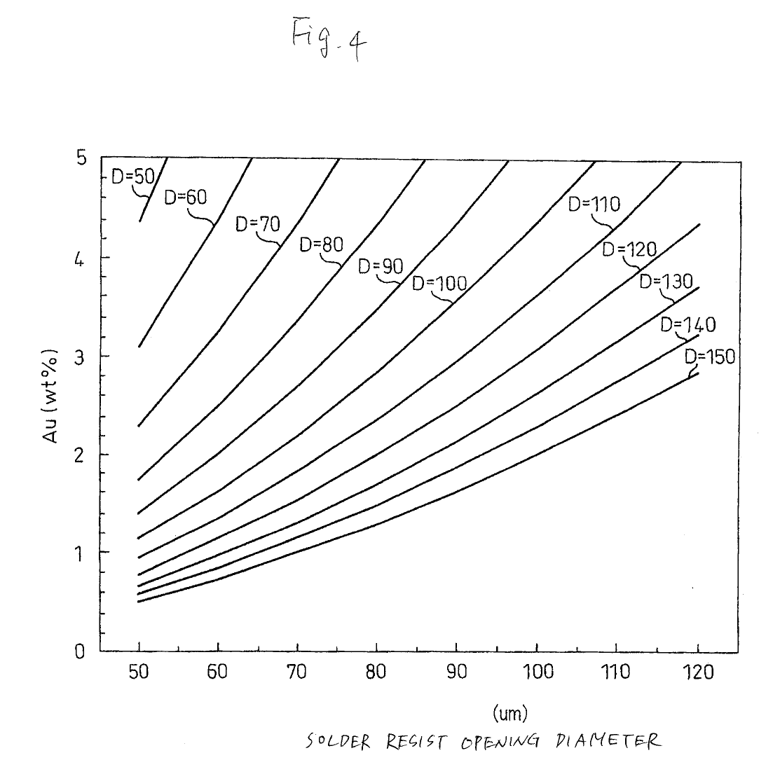

On the other hand, the content of the diffused substance in the solder after reflow on the pad having the predetermined opening diameter can simply be calculated by a calculation from an amount of the substance initially present as a portion of the pad and an amount of the solder supplied onto the pad. As an example, a graph of FIG. 4 shows a relationship between a solder resist opening diameter (which is equal to an opening diameter of the pad), and an amount of Au diffused from the pad in the solder. The graph shows a relationship between a solder resist opening diameter and an Au amount in the solder after reflow when a thickness of the Au layer is made to be 0.3 m, and the solder is supplied by a screen printing using a mask having a thickness of 50 μm by constituting a parameter by an opening diameter D (μm unit) of the mask.

### EXAMPLES

Next, although the invention will be explained further by examples shown below as follows, naturally, the invention is not limited thereto.

### Comparative Example

When an Sn—Ag eutectic solder is supplied to a substrate formed with pads by Ni layers and Au layers (thickness of Au layer is 0.4 μm) in opening portions of diameters 80 μm and 110 μm formed at a solder resist layer by screen printing of a transcribing amount of 50% using mask diameters 110 μm and 140 μm respectively for the pads of the diameters 80 μm and 110 μm and solder compositions after reflow are investigated, Au contents of the solder on the pads of the diameters 80 μm and 110 μm are respectively 2.68 wt % and 3.12 wt %, and there is a difference therebetween of about 0.44 wt %. When the solidifying points of the solders of the both are measured, there is a difference of about 8° C. The solidifying points in this case cannot be measured by general method of DSC measurement (differential scanning calorimetric measurement) but are measured as apparent solidifying points by visual observation.

### EXAMPLE

Next, when screen printing is carried out under the same condition except that the mask diameter for the pad of 110 μm is made to be 150 μm, Au contents of the solder on the pads of the diameters 80 μm and 110 μm can respectively 2.68 wt % and 2.73 wt %, and a difference therebetween becomes about 0.05 wt %, and the difference between the solidifying points is restrained to about 1° C.

Although an explanation has been given by taking an example of the substrate having the pad formed by the Ni layer and the Au layer, the invention is similarly applicable to a substrate having a pad fabricated by using a material (for example, Pd or the like) diffused into a solder in reflow. Further, even in a substrate formed with a solder bump directly on a Cu wiring, the invention is applicable in bonding a substrate and a chip without a connection failure or shortcircuit by adjusting an amount of diffusing Cu into the solder.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of supplying a solder to connection terminals having different opening diameters of a substrate, said method comprising a step of:
controlling amounts of the solder to supply onto the respective connection terminals such that a difference between contents of a substance diffused from the connection terminals into the solder by reflow, which is present in the solder after reflow on the connection terminals having the different opening diameters, becomes equal to or smaller than 0.2 wt %.

2. The solder supplying method according to claim 1, wherein the amounts of the solder are controlled to supply onto the respective connection terminals such that the difference between the contents of the substance diffused from the connection terminals into the solder becomes equal to or smaller than 0.1 wt %.

3. The solder supplying method according to claim 1, wherein the amounts of the solder are controlled to supply onto the respective connection terminals such that the difference between the contents of the substance diffused from the connection terminals into the solder becomes equal to or smaller than 0.05 wt %.

4. The solder supplying method according to claim 1, wherein the solder is supplied onto the connection terminal by screen printing, and the amount of supplying the solder is controlled by adjusting a mask diameter of the screen printing.

5. The solder supplying method according to claim 1, wherein the solder is supplied onto the connection terminal by a solder ball, and the amount: of supplying the solder is controlled by adjusting a diameter of the solder ball.

6. The solder supplying method according to claim 1, wherein the solder is supplied onto the connection terminal by supplying the solder melted by a melting method.

7. A method of supplying a solder to connection terminals having different opening diameters of a substrate, said method comprising steps of:
forming the connection terminals having different opening diameters on the substrate by controlling a thickness of the connection terminals such that a difference between contents of a substance diffused from the connection terminals into the solder by reflow, which is present in the solder after reflow on the connection terminals having the different opening diameters, becomes equal to or smaller than 0.2 wt %; and
supplying the solder to the respective connection terminals.
